(19) United States
(12) Patent Application Publication
(10) Pub. No.: US 2025/0389338 A1
(43) Pub. Date: Dec. 25, 2025

(54) ORIFICE CHECK VALVE

(71) Applicant: Enapter S.r.l., Crespina Lorenzana (IT)

(72) Inventors: Alessandro PERSICHETTI, Crespina Lorenzana (IT); Vito PINTO, Crespina Lorenzana (IT); Valerio CIRRI, Crespina Lorenzana (IT)

(21) Appl. No.: 18/993,499

(22) PCT Filed: Jul. 13, 2023
(86) PCT No.: PCT/EP2023/069579

§ 371 Date: Jan. 10, 2025

(30) Foreign Application Priority Data
Jul. 13, 2022 (GB) 2210309.7

(51) Int. Cl. F16K 15/02

(52) U.S. Cl. CPC F16K 15/028

(57) ABSTRACT

The present disclosure relates to a check valve (1) comprising: a valve housing (10); a valve member (11) within the housing, the valve member being movable between an open position and a closed position; and at least one restricted channel (14) through the valve member, wherein, in the closed position, the at least one restricted channel is arranged to allow a restricted backflow of fluid through the valve. The present disclosure also relates to a system comprising: an electrochemical device and the check valve, wherein the check valve is connected to an outlet pipeline of the electrochemical device.

### FIELD OF INVENTION

The present invention relates to a check valve with a restricted channel for equalising pressure differentials across the valve. The valve is intended for use with, but not necessarily limited to use with, electrolysers.

### BACKGROUND

Fluid flow in pipes is commonplace in numerous industries. There are many known means for controlling the flow of fluid including a wide range of valves. When necessary to direct the flow in a pipe, a check valve is used. this can be one of many types such as swing, lift, butterfly, stop or tilting disk.

In some instances, a complete stoppage of flow may not be desired so an orifice plate can be used to restrict fluid flow in the pipe. The issue here is that when an orifice plate is used flow is permanently restricted to parameters based upon the orifice dimension. This is not ideal in many applications where a higher flowrate is desired during normal operation or in a particular flow direction.

Furthermore, in some instances a traditional check valve which entirely prevents flow in one direction may also not be desirable because it can lead to problematic pressure differentials on either side of the check valve.

An object of the present invention is to provide an improved check valve allowing for the equalisation of pressure differentials across the check valve, and for enabling variable fluid flow rates in different direction.

### SUMMARY OF THE INVENTION

According to an aspect of the present invention there is provided a check valve comprising: a valve housing; a valve member within the housing, the valve member being movable between an open position and a closed position; and at least one restricted channel through the valve member, wherein, in the closed position, the at least one restricted channel is arranged to allow a restricted backflow of fluid through the valve.

Such a valve is particularly advantageous for use with electrochemical devices, such as electrolysers. These devices have a purge line that is opened to allow for the discharge of products generated during start up and shut down of the device and closed during normal operation conditions. However, a standard check valve is unsuitable for this regulating fluid flow along a purse line because, when closed, a standard check valve will entirely prevent backflow up the purge line to the device. This total prevention of backflow can be problematic in the event of a pressure drop inside the device (such as would occur during idling of the device) which can damage the device; therefore a restricted backflow of air through the purge line is desirable to prevent pressure drops within the device, but to restrict the backflow of gas/air to a level low enough that it is not dangerous for the electrochemical device. The valve also acts to protect the device against sudden external pressure shocks, by allowing gradual equalisation of pressure difference across the valve by allowing restricted fluid flow through the restricted channel.

Preferably, the check valve further comprises at least one further channel arranged to allow fluid flow through or around the valve member when the valve member is in the open position.

Preferably, the at least one further channel is at least one bypass channel in the housing arranged to provide a fluid flow path around the valve member.

Alternatively, the at least one further channel is at least one throughflow channel through the valve member arranged to provide a fluid flow path through the valve member.

Preferably, the at least one further channel has a larger cross sectional area that the at least one restricted channel.

Preferably, the valve member is arranged to extend across the interior of the housing.

Preferably, the valve member comprises sealing means for sealing the valve member against a part of the housing in the closed position.

Preferably, the sealing means is a gasket, more preferably an O-ring gasket.

Preferably, the sealing means is arranged on the valve member to surround an inlet or outlet of the at least one restricted channel.

Preferably, the sealing means is arranged to prevent fluid flow from an inlet of the valve housing through or around the valve member when the valve member is in the closed position.

Preferably, the at least one restricted channel is arranged in the centre of the valve member.

Preferably, the check valve comprises a biasing means within the housing arranged to bias the valve member into the closed position.

Preferably, the biasing means comprises at least one of: a spring, preferably a coil spring; a biased hinge; a poppet; and/or a compressible polymer.

Preferably, the biasing means is calibrated such that the valve member is arranged to move between from the open position to the closed position at a pressure of below 0.5 bar.

Preferably, the at least one restricted channel has a diameter of between 1 and 100 microns, preferably between 1 and 50 microns, more preferably between 1 and 20 microns, and yet more preferably between 5 and 15 microns.

Preferably, the check valve is one of: a swing check valve; a lift check valve; a butterfly check valve; a stop check valve; or a tilting disk check valve.

Preferably, the valve member is formed of stainless steel.

According to another aspect of the present invention, there is provided a system comprising: an electrochemical device; and a check valve according to any preceding claim, wherein the valve is connected to an outlet pipeline of the electrochemical device.

Preferably, the electrochemical device is an electrolyser.

Preferably, the outlet pipeline is a purge line of the electrolyser.

Preferably, the check valve further comprises at least one further channel arranged to allow fluid flow through or around the valve member when the valve member is in the open position, and the total cross sectional area of the at least one further channel is more than or equal to the cross sectional area of the outlet pipeline.

As used herein, the terms “orifice check valve”, “equalisation check valve” and “equilibrium check valve” may be used interchangeably. The restricted channel through the valve member is also referred to herein as an “orifice”.

The check valve described herein may be based upon any suitable check valve type such as but not necessarily limited to swing, lift, butterfly, stop or tilting disk valves.

In the preferred embodiment the valve housing is sized to be of a substantially similar diameter to the piping upon which the orifice check valve is to be placed. In this way, fluid flow in the forward direction is not restricted by the valve, and the valve allows fluid to flow therethrough at the same rate as it flows through the piping.

It is envisaged that when in the open position, the valve can accommodate substantially the same flow as the piping upon which the orifice check valve is to be placed.

It is envisaged that in the closed (i.e. seated) position, the valve member spans the entire flow path of the housing.

It is envisaged that a variety of means may be used to allow for the movement of the valve member. This can include a spring with a piston, a hinge on one end of the movable member, a poppet, a compressible polymer.

Whilst it is envisaged that the valve may be calibrated to open/close at a wide range of pressures, in a preferred embodiment of the present invention, the valve is calibrated such that it opens at a low pressure, such as below 0.5 bar, more preferably below 0.1 bar and more preferably still at substantially 0.05 bar. The above values being for a system designed to operate at substantially 35 bar. Alternatively, the ratio of operating pressure to activating pressure may be any one of or between any two of: 10:1, 50:1, 100:1, 250:1, 500:1, 700:1, 750:1 or 100:1.

In the preferred embodiment the valve member is a piston or equivalent with a sealing means, optionally an O-ring, gasket, or other sealing means is provided to ensure a fluid tight connection between the valve member and the valve housing such that the calibrated restricted channel is the only viable fluid path.

The dimensions of the restricted channel are preferably calibrated to limit the backflow rate to a level which is safe for the device with which the valve is used. In the preferred embodiment the restricted channel in the valve member is a micron scale hole. Preferably under 100 microns, more preferably still under 50 microns and even more preferably still under 20 microns. It is envisaged that the micron scale hole will be between 5 and 15 microns. The restricted channel may be anywhere on the valve member, including at the edge, however in a preferred embodiment the hole is located on the inner portion of valve member, and more preferably still substantially in the centre of the valve member. This siting allows for proper sealing at the borders.

In the preferred embodiment of the present invention there is one restricted channel. In an alternative embodiment there are 2 or more restricted channel, the total cross sectional area of said channels being calibrated in accordance with the present invention. In the event there is more than one channel it is envisaged that the distribution will be substantially uniform, such as two channels equidistant from the centre of the valve member and the circumference, or in an equilateral triangular arrangement for three channels, a square for four, and so on.

The valve member may be made of stainless steel or any suitable material.

It is envisaged that the present invention may be used in combination with any device or system. In a preferred embodiment, the present invention is utilised with electrolysers, and more preferably still AEM electrolysers.

To help understanding of the invention, a specific embodiment thereof will now be described by way of example and with reference to the accompanying drawings, in which:

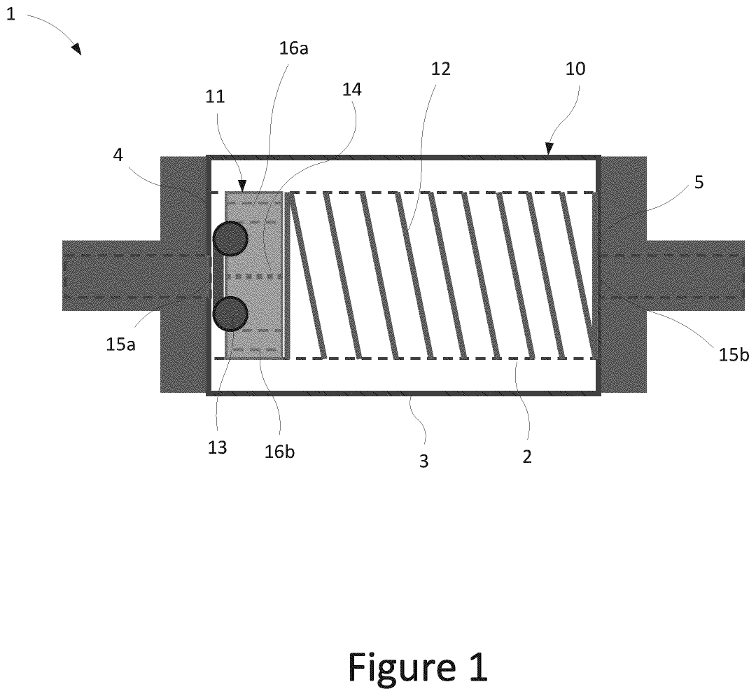

FIG. 1 shows the orifice check valve in a closed position;

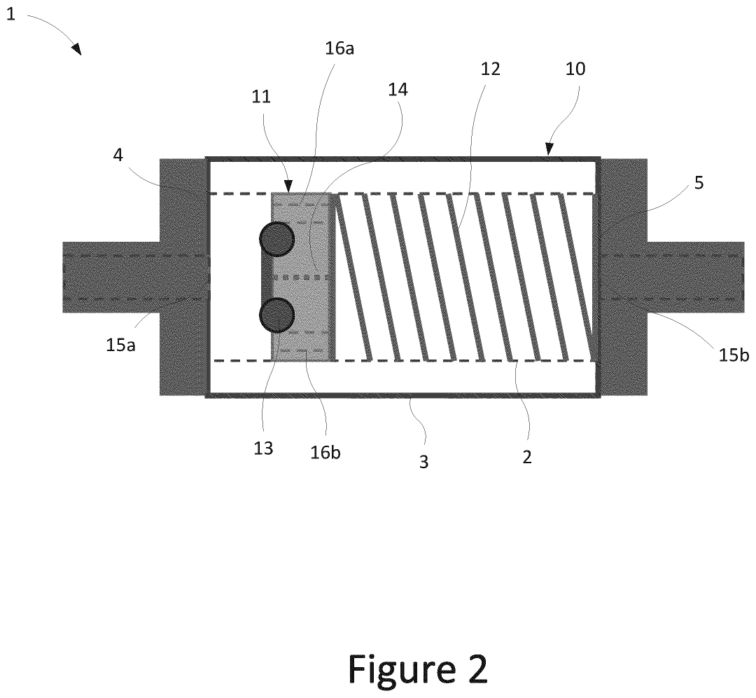

FIG. 2 shows the orifice check valve in an open position;

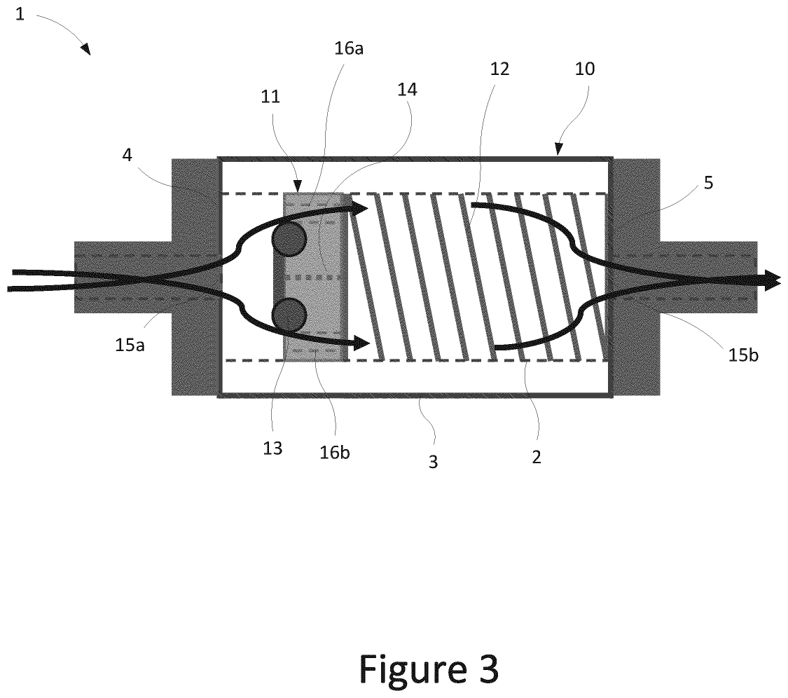

FIG. 3 shows the orifice check valve in an open position with fluid flow;

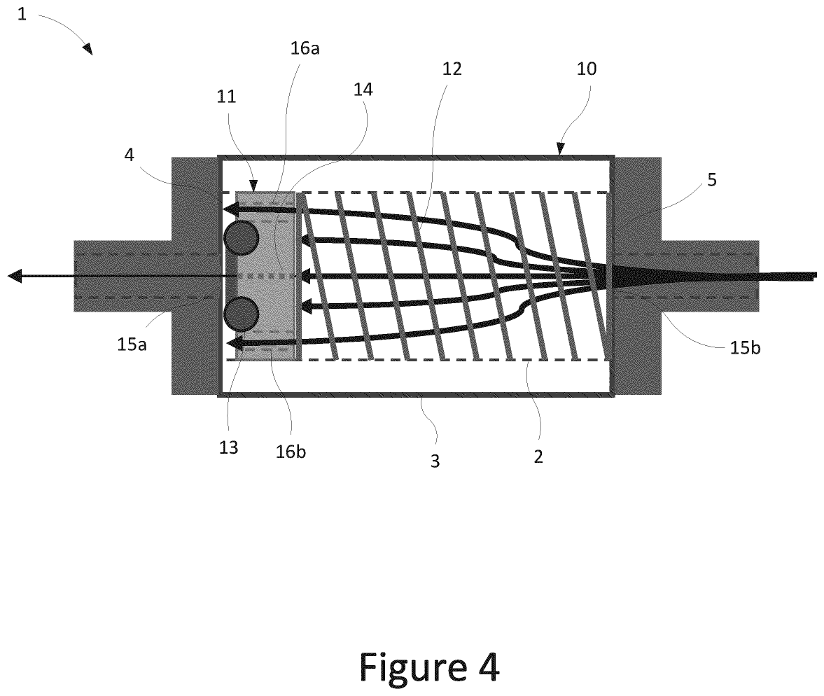

FIG. 4 shows the orifice check valve in a closed position with back flow; and

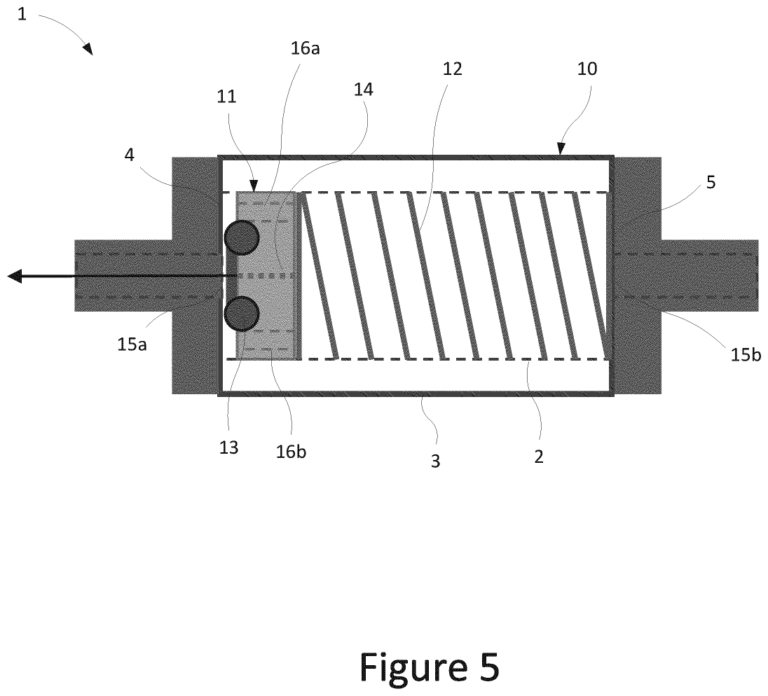

FIG. 5 shows the orifice check valve in a closed position allowing pressure equalisation.

### DETAILS DESCRIPTION

Referring to FIG. 1, the orifice check valve 1 can be seen with housing 10. The housing 10 encloses an internal cavity within the valve. Internal side walls 2 of the valve housing are shown with dashed lines, and external side walls 3 of the valve housing are shown with solid lines. The valve housing 10 also comprises two end walls, a first end wall 4 at a first end of the valve (which, in normal operation, is the upstream end of the valve) and a second end wall 5 at a second end of the valve (which, in normal operation, is the upstream end of the valve). The cavity is enclosed by the internal side walls 2 and the end walls 4, 5 of the housing.

The valve 1 comprises a first opening 15a in the first end wall 4 and a second opening 15b in the second end wall 5 for fluid flow into or out of the valve cavity. In this example, pipes extend from each opening 15a, 15b for directing fluid flow into or out of the cavity through the openings. In normal operation, the first opening 15a acts as an inlet of fluid into the valve cavity, and the second opening 15b acts as an outlet of fluid out of the valve cavity.

The valve 1 also comprises a valve member 11 which extends between the internal side walls 2 of the valve housing 10 such that the valve member 11 substantially spans the entire width of the internal cavity of the valve housing. The valve member 11 is movable within the cavity under or against the force of a biasing means, which in this example is a coil spring 12 located within the valve cavity. In this example, the valve member 11 is circular and the internal walls 2 of the valve housing 10 are cylindrical. The valve member 11 is movable through the valve cavity along the longitudinal axis of the valve, that is, along the axis from the first opening 15a to the second opening 15b. Thus, the valve member can be considered as a piston and the cavity within the valve housing can be considered a cylinder guiding the piston.

The valve member 11 is movable a closed position and an open position. In the example shown in FIG. 1, the valve member 11 is in the closed position under the force of the spring 12. The valve member comprises a sealing means, which in this example is an O-ring gasket 13. When the valve member 11 is in the closed position, the O-ring gasket 13 is pressed against the first end wall 4 under the force of the spring 12. The gasket ensures a tight seal against the first end wall 4. The O-ring gasket has a diameter which is at least as large as the diameter of the first opening 15a such that the gasket can seal around the opening 15a.

The valve member 11 comprises a restricted channel 14 passing through the valve member. In this example, the restricted channel 14 is a hole located through the centre of the valve member 11, specifically a micron scale hole. The channel 14 is located centrally in the valve member 11 such that it aligns with the first opening 15a and with the central opening in the O-ring gasket 13. The valve member 11 also comprises a pair of throughflow channels 16a, 16b, each passing through the valve member. The throughflow channels 16a, 16b are located on opposite sides of the O-ring gasket 13, and outside the O-ring gasket such that each throughflow channel is located between the gasket and the edge of the valve member 11. The throughflow channels 16a, 16b are wider than the restricted channel 14 through the centre of the valve member, thereby to allow a higher fluid flow rate therethrough as compared to the restricted channel 14. In other embodiments, the throughflow channels may be replaced instead by bypass channels in the housing, allowing fluid to bypass the valve member when it is in the open position.

FIG. 2 shows the valve 1 of FIG. 1 in the open position. In this case, fluid flow through the first opening 15a forces the valve member 11 away from the first end wall 4 against the spring 12. The O-ring gasket 13 is thus moved out of contact with the first end wall 4 thereby unsealing the opening 15a allowing flow through the valve as described below with reference to FIG. 3.

FIG. 3 shows the valve 1 in the open position, as in FIG. 2, but with the addition of lines denoting the direction of fluid flow through the valve. In the open position the spring 12 is compressed by the valve member 11 under the pressure of fluid flowing through the first opening 15a. In the open position the gasket 13 is moved out of contact with the first end wall 4, therefore opening a flow path for fluid flowing through the first opening 15a, around the gasket 13, and through the throughflow channels 16a, 16b. The flow thus can pass through the valve member 11 through the internal cavity of the valve and on through the second opening 15b out of the valve.

In use, the check valve 1 is connected in a fluid pipeline downstream from a device (e.g. an electrolyser) such that the first opening 15a is arranged to receive fluid from the upstream device and to act as an inlet to the valve, and the second opening 15b is arranged to release fluid from the valve to the pipeline downstream of the valve and thus acts as an outlet from the valve. In normal operation, fluid flows along the pipeline from the device to the valve, and the pressure of this forward fluid flow forces the valve member 11 open to allow fluid flow through the first opening 15a, through the throughflow channels 16a, 16b, and then out through the second opening 15b and onwards downstream.

FIG. 4 shows the opposite scenario to FIG. 3, wherein a fluid backflow causes the pressure to be higher at the second opening 15b than at the first opening 15a such that the spring 12 returns the valve member 11 into contact with the first end face 4, such that the O-ring gasket 13 seals the first opening 15a. As the valve member 11 and gasket 13 are in contact with the first end wall 4 of the housing 10 of the valve 1, backflow through the throughflow channels 16a, 16b and through the first opening 15a is not possible as the flow path is blocked by the gasket 13 sealing against the first end wall 4. Thus, the only backflow permitted is through the micron scale restricted channel 14 to opening 15a and onwards to the upstream device (not shown, but which may be for example an electrolyser). The restricted channel 14 therefore allows a restricted backflow of fluid through the valve to the upstream device so as to equalise the pressure difference across the valve caused either by external pressure shocks downstream of the valve (driving the backflow to the device) or under-pressure issues with the upstream device (sucking a backflow of fluid up to the device).

FIG. 5 shows the valve 1 as seen in FIG. 4, wherein the restricted channel 14 allows for restricted fluid flow through opening 15a towards the device upstream of the valve to avoid under pressure issues. It also prevents pressure shocks on the device as the valve 1 is in a closed position allowing only a restricted amount of fluid to flow back upstream, such as will not be problematic for the upstream device (e.g. electrolyser). The valve 1 thus imparts pressure resilience to the upstream device and allows for a gradual pressure equalisation.

An exemplary application utilising the present invention is the purge line of an electrolyser. With an electrolyser external pressure spikes can damage the electrochemical stack if the purge line is open. The common approach would be a check valve which prevents all fluid flow. This is problematic when the electrolyser is put on standby or otherwise switched off. An under pressure may occur which would damage the stack or improper membrane sealing which results in potential mixing of hydrogen and oxygen, most notably oxygen in the hydrogen line. The presence of the orifice check valve means that when closed, a small amount of ambient air can enter upstream should a pressure drop occur during idling of the electrolyser. This prevents damage to the electrolytic stack by allowing equalisation of pressure within the stack or other device. Other electrochemical devices can also employ the present invention in a similar manner.

On electrochemical devices such as electrolysers a purge line is often employed to allow for the discharge of generated products during start up and shut down. During normal operation the purge line should be closed, thanks to a solenoid valve to maintain the inner pressure After the turning off, the purge line is opened, the flow goes out and then the check valve will protect the electrochemical elements that can be negatively affected by external pressure spikes present in the common purging line. This closing, in some cases, can create a dangerous under pressure between the electrochemical elements and the check valve. To avoid this issue, it is necessary to equalise the pressure between a calibrated orifice that works in parallel with the check valve.

On the other hand, if a pressure spike in the common purging line will happen, it will not be dangerous for the electrochemical elements because the calibrated orifice will attenuate it.

The invention is not intended to be restricted to the details of the above described embodiment. For instance, the present invention may be constructed of any material, and used with any device which would benefit from the pressure resilience imparted by the orifice check valve.

It will be understood that the invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1. A check valve comprising:
a valve housing;
a valve member within the housing, the valve member being movable between an open position and a closed position; and
at least one restricted channel through the valve member,
wherein, in the closed position, the at least one restricted channel is arranged to allow a restricted backflow of fluid through the valve.

2. A check valve according to claim 1, comprising at least one further channel arranged to allow fluid flow through or around the valve member when the valve member is in the open position.

3. A check valve according to claim 2, wherein the at least one further channel is at least one bypass channel in the housing arranged to provide a fluid flow path around the valve member.

4. A check valve according to claim 2, wherein the at least one further channel is at least one throughflow channel through the valve member arranged to provide a fluid flow path through the valve member.

5. A check valve according to claim 2, wherein the at least one further channel has a larger cross sectional area that the at least one restricted channel.

6. A check valve according to claim 1, wherein the valve member is arranged to extend across the interior of the housing.

7. A check valve according to claim 1, wherein the valve member comprises sealing means for sealing the valve member against a part of the housing in the closed position.

8. A check valve according to claim 7, wherein the sealing means is a gasket, preferably an O-ring gasket.

9. A check valve according to claim 7, wherein the sealing means is arranged on the valve member to surround an inlet or outlet of the at least one restricted channel.

10. A check valve according to claim 7, wherein the sealing means is arranged to prevent fluid flow from an inlet of the valve housing through or around the valve member when the valve member is in the closed position.

11. A check valve according to claim 1, wherein the at least one restricted channel is arranged in the centre of the valve member.

12. A check valve according to claim 1, comprising a biasing means within the housing arranged to bias the valve member into the closed position.

13. A check valve according to claim 12, wherein the biasing means comprises at least one of: a spring, preferably a coil spring; a biased hinge; a poppet; and/or a compressible polymer.

14. A check valve according to claim 12, wherein the biasing means is calibrated such that the valve member is arranged to move between from the open position to the closed position at a pressure of below 0.5 bar.

15. A check valve according to claim 1, wherein the at least one restricted channel has a diameter of between 1 and 100 microns, preferably between 1 and 50 microns, more preferably between 1 and 20 microns, and yet more preferably between 5 and 15 microns.

16. A check valve according to claim 1, wherein the check valve is one of: a swing check valve; a lift check valve; a butterfly check valve; a stop check valve; or a tilting disk check valve.

17. (canceled)

18. A system comprising:
an electrochemical device; and
a check valve according to claim 1,
wherein the check valve is connected to an outlet pipeline of the electrochemical device.

19. A system according to claim 18, wherein the electrochemical device is an electrolyser.

20. A system according to claim 19, wherein the outlet pipeline is a purge line of the electrolyser.

21. A system according to claim 18, wherein the check valve comprises at least one further channel arranged to allow fluid flow through or around the valve member when the valve member is in the open position, and wherein the total cross sectional area of the at least one further channel is more than or equal to the cross sectional area of the outlet pipeline.
